(19) United States
(12) Patent Application Publication
(10) Pub. No.: US 2019/0291663 A1
(43) Pub. Date: Sep. 26, 2019

(54) MOTOR VEHICLE INTERFACE

(71) Applicant: Robert Bosch GmbH, Stuttgart (DE)

(72) Inventors: Andreas Heyl, Sunnyvale, CA (US); Claus Ritter, Waldbronn (DE); Herbert Reichardt, Aichwald (DE); Stefan Doehren, Remshalden-Grunbach (DE)

(21) Appl. No.: 16/303,424

(22) PCT Filed: May 12, 2017
(86) PCT No.: PCT/EP2017/061460

§ 371 Date: Jan. 16, 2019

(30) Foreign Application Priority Data
May 24, 2016 (DE) 10 2016 208 937.4

(51) Int. Cl. B60R 16/023; B60H 1/00; H04L 29/06; B60W 50/02

(52) U.S. Cl. CPC B60R 16/0239; B60H 1/00735; B60W 2050/0045; B60W 50/02; H04L 63/10

(57) ABSTRACT

An interface for providing a secure interface to a motor vehicle, in particular, for communication with control electronics of the motor vehicle, includes: a first interface having multiple terminals, which is configured for communication with control electronics of the motor vehicle; a second interface, which is for communication with an external diagnostic device; a first processing unit, which is to transmit data between the first and the second interface; a second processing unit, which is to monitor the data transmission between the first interface and the second interface, to recognize an unsafe state and to interrupt the data transmission if an unsafe state has been recognized; and a circuit, which enables terminals of the first interface to be selectively connected to inputs and/or outputs of the first processing unit and/or the second processing unit.

### FIELD OF THE INVENTION

The present invention relates to an interface for providing an interface in a motor vehicle, in particular, for communication with control electronics of the motor vehicle, which enable a secure data communication.

### BACKGROUND INFORMATION

The progressive interlinking of motor vehicles, in particular, via the Internet, and the accompanying increasing number of use cases, means an increasingly greater amount of pieces of information/data from a motor vehicle is required.

The legally required OBD2 interface is provided as a generic, manufacturer-wide data access point for exhaust-relevant systems. This interface is used today in repair shops as the primary diagnosis access point.

The OBD2 interfaces are known, which are plugged into the OBD2 connector of a motor vehicle and which provide an interface that enables a diagnostic communication with suitable application software. This interface may be configured as a hard-wired or wireless interface and, in particular, as a functional interface. The application software may be operated in a diagnostic device specifically provided for such purpose, but also in a multifunctional device such as, for example, a mobile telephone (smartphone), a tablet computer or a notebook.

Various applications are limited to reading out diagnostic data from the motor vehicle, which may be requested during driving operation and/or when the motor vehicle is stopped. The applications generally explicitly do not include erasing the error memory. With respect to functional safety, therefore, (following ISO26262, which is not directly applicable to OBD interfaces), no particular safety requirements must be observed.

In more complex applications, however, higher functional safety requirements (similar to the ASIL level) are also achieved, which must be ensured accordingly. For example, an unintended activation, resulting for example from a malfunction of the software and/or from a faulty operation of a user, of an ESP system that activates the brakes, would be very dangerous in various driving situations.

### SUMMARY OF THE INVENTION

It is therefore the object of the present invention to provide an interface for providing an interface in a motor vehicle, which is not limited to reading out diagnostic data from the motor vehicle and which satisfies higher safety requirements in the process.

It is, in particular, an object of the present invention to provide an interface for providing an interface in a motor vehicle, which meets at least ASIL-A when similarly applying the ISO26262.

According to one exemplary embodiment of the present invention, an interface for providing a secure interface to a motor vehicle, in particular, for communication with control electronics of the motor vehicle, includes a first interface having multiple terminals, which is configured for communication with control electronics of the motor vehicle; a second interface, which is configured for communication with an external diagnostic device; and a first processing unit, which is configured to transmit data between the first interface and the second interface. In this arrangement, data may be transmitted in both directions. For example, diagnostic data from the first interface (the motor vehicle) may be transmitted to the second interface (diagnostic device) and/or instructions may be transmitted from the second interface (the diagnostic device) to the first interface (the motor vehicle).

The interface also has a second processing unit, which is configured to monitor the data transmission between the first interface and the second interface, to recognize an impermissible data transmission, and to interrupt the data transmission if an impermissible data transmission has been recognized; and a circuit that enables individual terminals of the first interface to be selectively connected to inputs and/or outputs of the first processing unit and/or of the second processing unit.

In one interface according to one exemplary embodiment of the present invention, the second processing unit has a “masking function”: the second processing unit carries out methods for error detection and plausibility checking independently of the first processing unit, which enable the data to be transmitted to be checked for impermissible contents and, if necessary, to prevent such impermissible contents from being transmitted to the motor vehicle. In this way, a high level of safety may be implemented, which corresponds at least to ASIL-A when similarly applying the ISO26262.

In one specific embodiment, the circuit includes a circuit matrix, which enables the inputs and outputs of the first processing unit to be selectively connected to various terminals (pins) of the first interface. In this way, the function of the interface may be variably adapted to various applications.

In one specific embodiment, the circuit is configured as an “application-specific integrated circuit (ASIC)”. In this way, the circuit may be implemented in a particularly efficient, space-saving and cost-effective manner.

In one specific embodiment, the circuit includes at least one receiver module, which enables signals that are (to be) transmitted via the first interface to the motor vehicle to also be transmitted to the second processing unit, so that the second processing unit may verify the signals to be transmitted, independently of the first processing unit, and may interrupt the data transmission if an inadmissible data transmission is determined.

In one specific embodiment, the first processing unit and the second processing unit are configured in a shared dual core processor. In this way, the first processing unit and the second processing unit may be provided in a particularly space-saving and cost-effective manner.

In one specific embodiment, the interface, in particular, the circuit, includes at least one watchdog module, which is configured to monitor the operation of the first processing unit and/or of the second processing unit and to deactivate the interface if a malfunction of the first processing unit and/or of the second processing unit is determined. The use of such a watchdog module may increase still further the operating safety of the interface.

In one specific embodiment, the circuit includes a de-energizing circuit, which enables the interface to be deactivated in a short period of time, in order to prevent a further transmission of data by the interface. In this way, an impermissible data transmission may be quickly and reliably interrupted.

In one specific embodiment, the de-energizing circuit includes a de-energizing path configured in hardware between the second processing unit and the watchdog. In this way, the data transmission from the second processing unit may be particularly quickly and reliably interrupted.

In one specific embodiment, the circuit is configured to receive data about the instantaneous status of the motor vehicle, in particular, about its movement status. This enables the transmission of data from the motor vehicle or to the motor vehicle to be permitted or to be prevented as a function of the instantaneous status of the motor vehicle.

For this purpose, the electronic circuitry may include, in particular, a motor vehicle status recognition module, which is configured to receive pieces of information from external sensors about the instantaneous status of the motor vehicle and to provide these pieces of information to the circuit, in particular, to the second processing unit. In this arrangement, the data may be transmitted from the motor vehicle status recognition module to the second processing unit, in particular, via corresponding SPI modules.

In one specific embodiment, the interface is configured as an OBD dongle. In this case, the first interface is configured for communication with the OBD/OBD2 interface of a motor vehicle. In this way, the interface may be connected in a simple manner, in particular, to its control unit, for exchanging data with the electronics of any motor vehicle that has an OBD/OBD2 interface.

The present invention may also be used in combination with older legacy interfaces via suitable adapters.

### BRIEF DESCRIPTION OF THE DRAWINGS

FIG. 1 schematically shows a block diagram of an interface 2 according to one exemplary embodiment of the present invention.

FIG. 2 schematically shows a block diagram of an interface 2 according to a second exemplary embodiment of the present invention.

### DETAILED DESCRIPTION

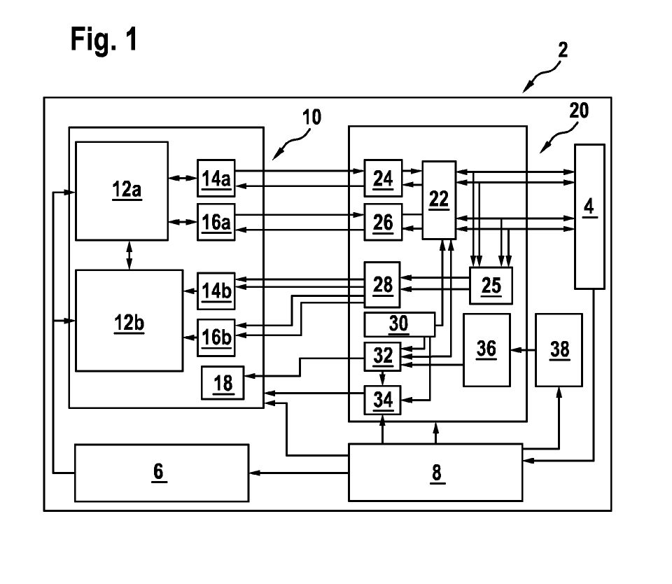

FIG. 1 schematically shows a block diagram of an interface 2 according to a first exemplary embodiment of the present invention.

Interface 2 includes a first interface 4, which is configured for communication with control electronics of a motor vehicle (not shown in the figure). The control electronics may include, in particular, one or multiple control units. First interface 4 may be configured, in particular, as an OBD or OBD2 interface, in order to communicate with one or multiple control units of the motor vehicle.

Interface 2 also includes a second interface 6, which is configured for communication with an external diagnostic device (not shown). The external diagnostic device may be a device specifically configured for motor vehicle diagnosis, or a computer, tablet computer or mobile telephone (smartphone), on which a software (“App”) suitable for motor vehicle diagnosis is installed.

The data may be transmitted via second interface 6 to the external diagnostic device in a hard-wired or wireless manner (for example, via WLAN, Bluetooth® or via a similar technology).

An energy supply module 8 supplies all components of interface 2 with electrical energy.

Interface 2 also includes a first processing unit 12a and a second processing unit 12b, which are configured in the shown exemplary embodiment as two processor cores 12a, 12b of a dual core processor 10. Alternatively, first and second processing units 12a, 12b may be configured as separate processors.

Interface 2 also includes an electrical circuit 20, which connects first processing unit 12a and second processing unit 12b to first interface 4. Circuit 20 may be configured, in particular, as an “application-specific integrated circuit (ASIC)”.

First and second processing units 12a, 12b each also include two communication controllers 14a, 14b, 16a, 16b, which are configured to be redundant and independent of one another. Communication controllers 14a, 14b, 16a, 16b may be configured, in particular, as CAN controllers 14a, 14b and as UARTS controllers 16a, 16b.

Electronic circuit 20 includes both a CAN transceiver 24 and a UART transceiver 26, each of which is configured for communication with the CAN controller and with UART controller 16a of first processing unit 12a, in order in this way to enable a communication between first processing unit 12a and electronic circuit 20.

Provided between CAN transceiver 24, UART transceiver 26 and first interface 4 as part of circuit 20 is a so-called “switch matrix” 22, which enables the inputs and outputs of CAN transceiver 24 and of UART transceiver 26 to be selectively connected to different terminals (“pins”) of first interface 4.

In the first exemplary embodiment shown in FIG. 1, the signals transmitted via first interface 4 between switch matrix 22 and first interface 4 are tapped on the physical layer, transferred by a level converter 25 to the logic level and fed to second processing unit 12b via a receiver module 28, which is configured for communication with second CAN controller 14b and with second UARTS controller 16b.

Electronic circuit 20 also includes an SPI module 32 and a motor vehicle status recognition module 36. Motor vehicle status recognition module 36 is configured to received pieces of information from external sensors 38, for example, acceleration sensors and/or velocity sensors, about the instantaneous (driving) status of the motor vehicle, and to provide these pieces of information to second processing unit 12b via SPI module 32 of circuit 20 and via a corresponding SPI module 18, which is connected to second processing unit 12b.

The conveyance of data regarding the instantaneous motor vehicle status allows the conveyance of different data, which may contain instructions and messages, to be enabled or to be blocked, as a function of the motor vehicle type, which is ascertained, for example, by reading in the vehicle identification number (FIB or VIN), of the instantaneous velocity of the motor vehicle (v=0 km/h or v>0 km/h), of the instantaneous position of the motor vehicle, which may be ascertained, for example, based on GPS data, in order to determine whether the motor vehicle is located, for example, in the repair shop. For example, instructions and messages that initiate tests of actuators, may only be transmitted if the motor vehicle is in a safe state, in particular, is stopped.

A watchdog module 30 monitors the operation of first and second processing units 12a, 12b, as well as electronic circuit 20 and deactivates interface 2 and/or carries out the restart thereof by activating a reset module 34, if a malfunction of one of the monitored components is determined.

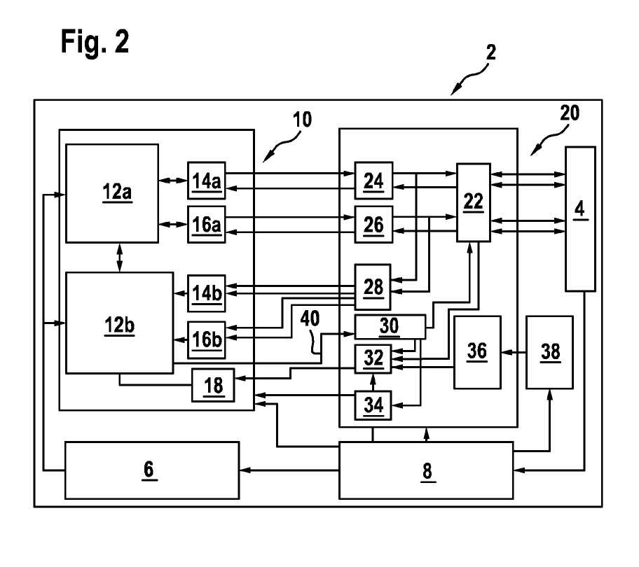

FIG. 2 schematically shows a block diagram of an interface 2 according to a second exemplary embodiment of the present invention.

Those components of the second exemplary embodiment that correspond to the components of the first exemplary embodiment are identified by the same reference numerals and are not described in detail again.

Whereas the signals in the first exemplary embodiment are tapped directly at the physical terminals (pins) of first interface 4 based on the physical layer, the signals in the second exemplary embodiment are tapped on the logic level within circuit 20, in particular, between CAN transceiver 24/UART transceiver 26 and switch matrix 22.

Thus, a level converter 25, as it is provided in the first exemplary embodiment, in order to transfer signals from the physical layer to the logic layer, may be dispensed with.

A de-energizing path 40 configured in hardware is also provided in the second exemplary embodiment between second processing unit 12b and watchdog 30. De-energizing path 40 enables second processing unit 12b to communicate directly with watchdog 30, in order to very quickly interrupt the data transmission via the first interface 4 if needed.

Various mechanisms for error detection and plausibility checking, which are described below by way of example and not fully, enable the data to be transmitted to be checked for impermissible contents and, if necessary, to prevent such impermissible contents from being transmitted.

The data to be transmitted via first interface 4 are tapped upstream (2^{nd} exemplary embodiment) or downstream (1^{st} exemplary embodiment) from switch matrix 22 and fed via receiver module 28 to second processing unit 12b for verification (if necessary after being transferred to the logic level by level converter 25).

Second processing unit 12b is able to recognize impermissible diagnostic data and to interrupt the transmission of data via first interface 4 to the motor vehicle. Various options are available for such purpose, which may be alternatively or cumulatively implemented.

Second processing unit 12b, once it has recognized the impermissible diagnostic data, may give watchdog 30 deliberately false answers in order to ensure that watchdog 30 stops the further transmission of data, for example, by switching switch matrix 22 to high resistance.

In the second exemplary embodiment shown in FIG. 2, second processing unit 12b may switch switch matrix 22 to high resistance via a direct signal line 40 to watchdog 30, which provides a de-energizing path configured in hardware, in order to interrupt the data transmission via first interface 4.

One possibility for interrupting the data transmission is that second processing unit 12b prompts first processing unit 12a to interrupt the transmission of data via first interface 4.

Second processing unit 12b may, for example, interrupt a HS-CAN communication after the tenth CRC check sum bit if the data have been classified as impermissible. The control unit of the motor vehicle will then ignore the data due to an invalid CRC.

In all cases, the de-energizing path is configured, in particular, in such a way that it may be activated within a short time window of, for example, 20 μs.

After an error detection, for example, second processing unit 12b also generates an error frame on the CAN bus via a request from second processing unit 12b to that of first processing unit 12a, before switch matrix 22 is deactivated or switched to high resistance.

Since second processing unit 12b also receives via switch matrix 22 and receiver module 28 the data to be transmitted, second processing unit 12b may not only check the validity of the content of the CAN data, but may also carry out a plausibility check of the generation of the data in first processing unit 12a (“Do I arrive at the same result as first processing unit 12a?”), and may effectuate an interruption of the data transmission if this plausibility check yields a negative result.

In order to check the arithmetic operation of first processing unit 12a, first processing unit 12a may transmit the data to be conveyed to the motor vehicle to second processing unit 12b for verification, even before the message is transmitted to electronic circuit 20. Not until second processing unit 12b has positively verified and confirmed the data, are the data released by first processing unit 12a and transmitted to electronic circuit 20. In addition, second processing unit 12b may quickly deactivate electronic circuit 20 via direct de-energizing path 40.

To verify the transmission path from first processing unit 12a to submodules of electronic circuit 20, second processing unit 12b may feed additional data into first processing unit 12a and read them back via electronic circuit 20. With this configuration, the functionality of the monitoring path as well as of de-energizing path 40 may also be checked.

The function of second processing unit 12b may be verified by a separate hardware in electronic circuit 20, for example, by a watchdog 30, which carries out a question/answer sequence. If a false answer is given by second processing unit 12b or the answer does not follow within a predefined time window, an error counter is incremented. The error counter is decremented if a correct answer is given in the predefined time window.

If the error counter reaches a predefined value, the further data transmission is interrupted, in particular, by switching switch matrix 22 to high resistance, so that no signals may be transmitted from interface 2 to the motor vehicle via first interface 4. In addition, the reset module may be activated 34 in order to reset interface 2.

The functionality of the question/answer sequence is periodically verified by second processing unit 12b by giving deliberately false answers and/or correct answers outside the time window. In the process, the incrementing and decrementing of the error counter is monitored by second processing unit 12b.

If, as in the second exemplary embodiment, second processing unit 12b has a direct access to de-energizing path 40 of watchdog 30, the question-answer play for verifying the functionality of first processing unit 12a and/or of second processing unit 12b may also be carried out directly between first processing unit 12a and second processing unit 12b.

1-11. (canceled)

12. An interface for providing a secure interface to a motor vehicle, for communication with control electronics of the motor vehicle, comprising:
a first interface having multiple terminals for communication with control electronics of the motor vehicle;
a second interface for communication with an external diagnostic device;
a first processing unit to transmit data between the first interface and the second interface;
a second processing unit to monitor the data transmission between the first interface and the second interface, so as to recognize an impermissible data transmission, and to interrupt the data transmission if an impermissible data transmission has been recognized; and
a circuit, which enables terminals of the first interface to be selectively connected to inputs and/or outputs of the first processing unit and/or of the second processing unit.

13. The interface of claim 12, wherein the circuit includes a switch matrix.

14. The interface of claim 12, wherein the circuit includes an ASIC.

15. The interface of claim 12, wherein the circuit includes at least one receiver module, which enables the signals that are transmitted via the first interface to the motor vehicle, to also be transmitted to the second processing unit.

16. The interface of claim 12, wherein the first processing unit and the second processing unit are included in a shared processor.

17. The interface of claim 12, wherein the circuit includes at least one watchdog module to monitor the operation of the first processing unit, the second processing unit and/or the circuit, and to deactivate the interface if a malfunction of the second processing unit and/or of the circuit is determined.

18. The interface of claim 12, wherein the circuit includes a de-energizing circuit, which enables the interface to be quickly deactivated and a further transmission of data by the interface to be prevented.

19. The interface of claim 18, wherein the de-energizing circuit includes a de-energizing path designed in hardware between the second processing unit and the watchdog.

20. The interface of claim 12, wherein the circuit is configured to receive data about the instantaneous status of the motor vehicle, in particular, about its movement status.

21. The interface of claim 20, wherein the circuit includes a motor vehicle status recognition module to receive pieces of information from external sensors about the instantaneous status of the motor vehicle and to provide these pieces of information to the circuit and/or the second processing unit.

22. The interface of claim 12, wherein the interface includes an OBD dongle and the first interface is for communication with the OBD/OBD2 interface of a motor vehicle.
